(19) United States
(12) Patent Application Publication
(10) Pub. No.: US 2022/0325559 A1
(43) Pub. Date: Oct. 13, 2022

(54) Magnetic Lock

(71) Applicant: Che-Yu Lee, New Taipei City (TW)

(72) Inventor: Che-Yu Lee, New Taipei City (TW)

(21) Appl. No.: 17/228,751

(22) Filed: Apr. 13, 2021

(51) Int. Cl. E05B 47/00

(52) U.S. Cl. CPC E05B 47/0045

(57) ABSTRACT

The invention falls within the technical field of safety equipment, in particular relates to a magnetic lock, which comprises a fixed component and a movable component. The movable component is used to connect with an external structure, and a sliding component arranged in the shell in a sliding way and a rotating part arranged in the shell in a rotating way, the rotating component is provided with a magnetic part, a locking piece is arranged at one end of the sliding component close to the movable component, and the movable component is provided with a fastener to fit with the locking piece, and the shell is provided with a through hole for exposing the locking piece and allowing the fastener to be inserted. When an external magnetic key is arranged close to the magnetic component, the magnetic component drives the rotating component to be in contact with the sliding component and drives the sliding component to slide away from the locking piece. The magnetic lock in the invention features a relatively simple structure, and can be unlocked without aligning the key to the lock hole, thereby increasing convenience of operation.

### TECHNICAL FIELD

The invention falls within the technical field of safety equipment, in particular relates to a magnetic lock.

### BACKGROUND ART

The conventional non-magnetic luggage lock comprises a key and a key body, and the key is required to be inserted into the lock hole to unlock it. The conventional non-magnetic lock features a complex structure, the user needs to closely align the key with the lock hole during operation, the lock surface is easily scratched, and operation is inconvenient compared to magnetic locks.

### CONTENTS OF THE INVENTION

In order to overcome the disadvantages and deficiencies existing in the prior art, the invention aims to provide a magnetic lock featuring a simple structure, which can be unlocked without requiring a key to be aligned with the lock hole, thereby increasing convenience of operation.

The invention is realized via the following technical proposal:

The magnetic lock in the invention comprises a fixed component and a movable component, wherein the movable component is used to connect with an external structure, the fixed component comprises a shell, a sliding component arranged in the shell in a sliding way and a rotating component arranged in the shell in a rotating way, the rotating component is provided with a magnetic component, a locking piece is arranged at one end of the sliding component close to the movable component, the movable component is provided with a fastener for fitting with the locking piece, and the shell is provided with a through hole for exposing the locking piece and allowing the fastener to be inserted. When an external magnetic key is arranged close to the magnetic component, the magnetic component drives the rotating component to be in contact with the sliding component and drives the sliding component to slide away from the locking piece.

The magnetic lock also consists of a returning component arranged in the shell, and the returning component is positioned between the sliding component and the shell.

The fastener comprises a base and an insertion hole arranged on the base, and the shape of the insertion hole matches the shape of the locking piece.

A first curved surface is installed on one side of the locking piece close to the fastener, and a second curved surface matching the first curved surface is arranged on one side of the fastener close to the locking piece.

The rotating component consists of a rotating block and two rotating shafts. The rotating shafts are arranged on either side of the rotating block and are rotationally connected to the shell, the magnetic component is arranged on the rotating block, a contact piece is arranged at one end of the rotating block close to the sliding component by folding and extending downwards, and an extension piece for maintaining contact with the contact piece is arranged at one end of the sliding component close to the rotating block.

A holding slot is arranged on the rotating block, and a magnetic component is kept in the holding slot.

The extension piece adopts an L-shaped structure and is integrated with the sliding component.

A yielding slot is arranged at the non-end position of the sliding component, and the rotating component is positioned in the yielding slot.

The invention has the following beneficial effects:

1. A simplified structure: compared with traditional key locks, the magnetic lock in the invention does not require a lock cylinder, and achieves the same effect as the traditional key lock.

2. Convenient operation: the invention can realize unlocking through fitting with an external magnetic key, without requiring a key to be aligned with and inserted into the lock hole, increasing the convenience of unlocking.

### DRAWING DESCRIPTION

The invention is further explained in the subsequent drawings, but the embodiments in the drawings do not constitute any limitation on the invention. General technicians in this field may obtain other drawings according to the following drawings without creative effort.

FIG. 1 is a schematic diagram of the three-dimensional structure of Embodiment 1.

FIG. 2 is a schematic diagram of the internal structure of Embodiment 1.

FIG. 3 is the other schematic diagram of the internal structure of Embodiment 1.

FIG. 4 is the other schematic diagram of the internal structure of Embodiment 1.

FIG. 5 is a structural diagram of Embodiment 2.

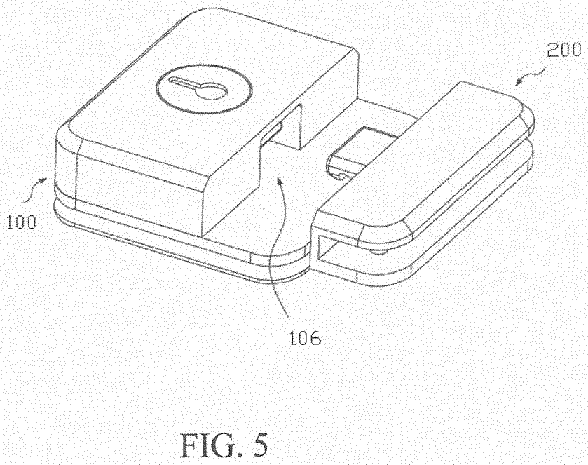

FIG. 6 is a schematic diagram of the internal structure of Embodiment 2.

FIG. 7 is an alternate schematic diagram of the internal structure of Embodiment 2.

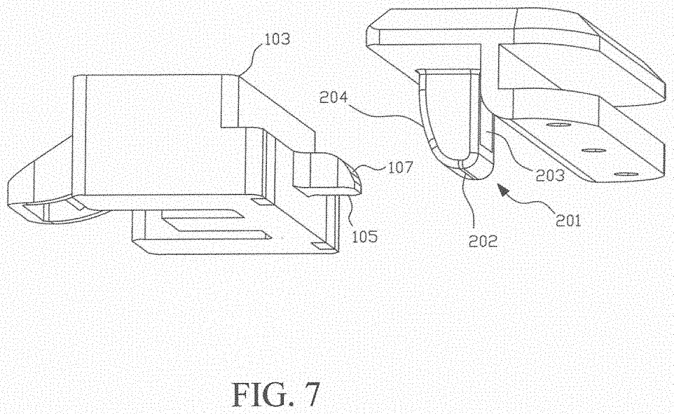

FIG. 8 is a structural diagram of the magnetic key.

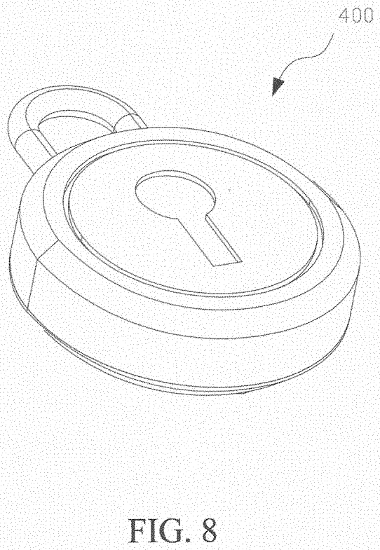

FIG. 9 is a material selection diagram of the magnetic component, magnetic key and returning component.

### DRAWING REFERENCE

Fixed component: 100; shell: 101; sliding component: 102; rotating component: 103; magnetic component: 104; locking piece: 105; full-depth hole: 106; first curved surface: 107; rotating block: 108; rotating shaft: 109; contact component: 110; extension component: 111; holding slot: 112; yielding slot: 113; movable component: 200; fastener: 201; base: 202; insertion hole: 203; second curved surface: 204; returning component: 300; magnetic key: 400.

### EMBODIMENTS

The implementation mode of the invention is described in the following embodiments. General technicians in this field will be able to easily understand the other advantages and effects of the invention based on the contents disclosed in this specification. The invention can also be implemented or applied in alternate specific implementation modes, and the details outlined in the specification can also be embellished or changed on the basis of different points of view or applications without deviating from the spirit of the invention.

It should be noted that the structures shown in the drawings of the specification are only used to match with the contents revealed in the specification and to enable understanding and reading by persons familiar with the technology, not to limit the invention, so the structures described herein are of no technical substance. Any embellishment or adjustment to the invention's structures shall be within the scope of technical contents revealed in the invention, without affecting the effects generated or purpose achieved via the invention.

### Embodiment 1

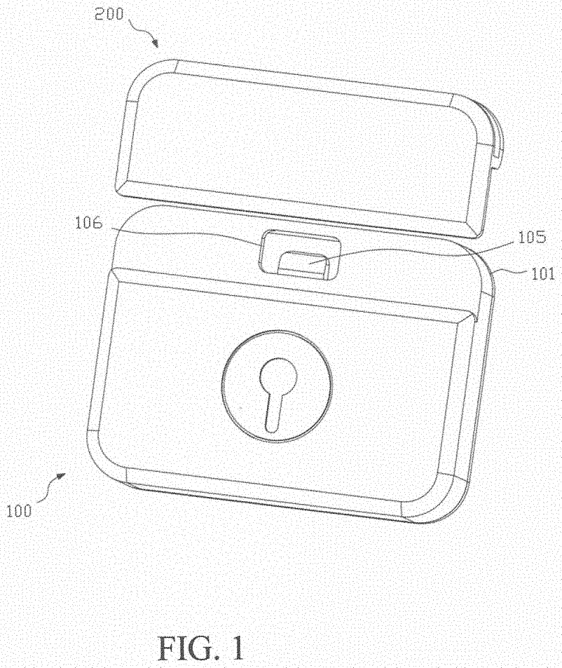

As shown in FIG. 1 to FIG. 4, the embodiment discloses a magnetic lock, which comprises a fixed component (100) and a movable component (200), wherein the movable component (200) is used to connect it to an external structure. The fixed component (100) comprises a shell (101), a sliding component (102) arranged in the shell (101) in a sliding way and a rotating component (103) arranged in the shell (101) in a rotating way. The rotating component (103) is provided with a magnetic component (104), a locking piece (105) is arranged at one end of the sliding component (102) close to the movable component (200), the movable component (200) is provided with a fastener (201) to fit with locking piece (105), and the shell (101) is provided with a through hole (106) for exposing the locking piece (105) and inserting the fastener (201). When an external magnetic key (400) is arranged close to the magnetic component (104), the magnetic component (104) drives the rotating component (103) to be in contact with the sliding component (102) and drives the sliding component (102) to slide away from the locking piece (105).

Specifically, the fastener (201) is inserted into the hole (106) while the magnetic lock in the embodiment is in a locked state, and is fastened using the locking piece (105). When the magnetic lock in the embodiment is required to be unlocked, the external magnetic key (400) is fitted with the shell (101) and absorbed with the magnetic component (104) positioned in the shell (101), the magnetic component (104) drives the rotating component (103) to enter into contact with the sliding component (102) and drives the sliding component (102) to slide away from the locking piece (105), and the locking piece (105) is separated from the fastener (201) to complete the unlocking process.

In the embodiment, the magnetic lock also comprises a returning component (300) arranged in the shell (101), and the returning component (300) is positioned between the sliding component (102) and the shell (101). The returning component (300) provides thrust to the sliding component (102) whenever the locking piece (105) is fastened to the fastener (201), so the locking piece (105) is always fastened with the fastener (201) in the absence of the magnetic key (400). Preferably, a spring or two magnets are used as the returning component (300) within the included embodiment.

Specifically, the fastener (201) comprises a base (202) and an insertion hole (203) arranged on the base (202), and the shape of the insertion hole (203) is matched to the shape of the locking piece (105). In the embodiment, the opening of the through hole (106) is upward, allowing the fastener (201) to be fastened with the locking piece (105) to enable locking after the fastener (201) is inserted into the through hole (106) and the locking piece (105) is inserted into the insertion hole (203).

In addition, the first curved surface (107) is arranged on one side of the locking piece (105) close to the fastener (201), and a second curved surface (204) matching the shape of the first curved surface (107) is arranged on one side of the fastener (201) close to the locking piece (105). As the fastener (201) is constantly inserted into the hole (106), the first curved surface (107) comes in contact with the second curved surface (204) and pushes the sliding component (102) away from the through hole (106). After this, the locking piece (105) gradually detaches from the second curved surface (204) and is inserted into the insertion hole (203) after reaching the position of the insertion hole (203). The matching of first curved surface (107) and second curved surface (204) can play a guiding role in the connection of the fastener (201) and locking piece (105).

Specifically, the rotating component (103) comprises a rotating block (108) and two rotating shafts (109). The two rotating shafts (109) are arranged on either side of the rotating block (108) and are rotationally connected to the shell (101). The magnetic component (104) is arranged on the rotating block (108), a contact piece (110) is arranged at one end of the rotating block (108) close to the sliding component (102) by folding and extending downwards, and an extension component (111) for enabling contact with the contact piece (108) is installed at one end of the sliding component (102) close to the rotating block (108). The linkage between the rotating component (103) and the sliding component (102) can be realized by fitting the contact piece (110) to the extension piece (111). Preferably, the extension piece 111 should adopt an L-shaped structure and is integrated with the sliding component (102), further extending the service life of the embodiment.

A holding slot (112) is installed on the rotating block (108), and a magnetic component (104) is arranged in the holding slot (112). The holding slot (112) is arranged in the middle of the rotating block (108), and the magnetic component (104) is arranged in the holding slot (112), allowing an internal space to be conserved within the magnetic lock, further reducing the volume of the invention.

Specifically, a yielding slot (113) is arranged at the non-end position of the sliding component (102), and the rotating component (103) is positioned in the yielding slot (113). The yielding slot (113) can make the sliding component (102) give way to the rotating component (103) as it slides, thereby avoiding a collision between the sliding component (102) and the rotating component (103).

### Embodiment 2

Compared with the magnetic lock described in Embodiment 1, the magnetic lock in Embodiment 2 contains no sliding component (102). The locking piece (105) is correspondingly arranged on the rotating component (103), and the opening of the through hole (106) is forward-oriented. The locking piece (105) is clamped to the fastener (201) instead of inserting the fastener (201), and the returning component (300) directly acts on the magnetic component (104). Compared with the magnetic lock described in Embodiment 1, the magnetic lock in Embodiment 2 features a more compact structure, and is suitable for other applications, such as being locked by pushing back and forth.

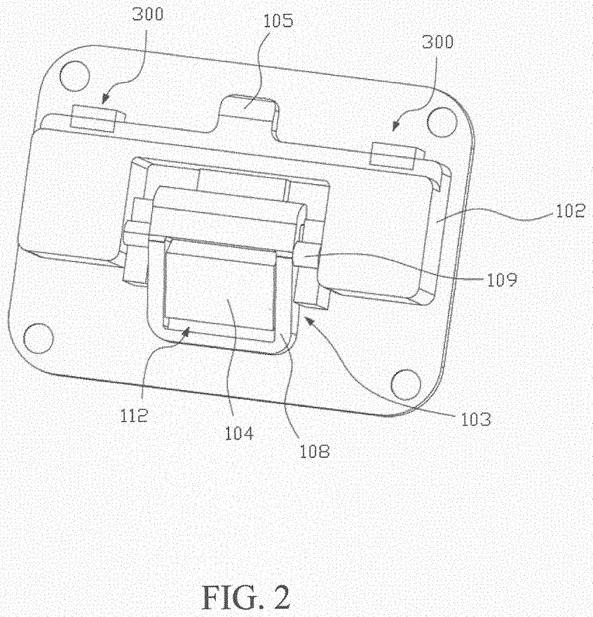

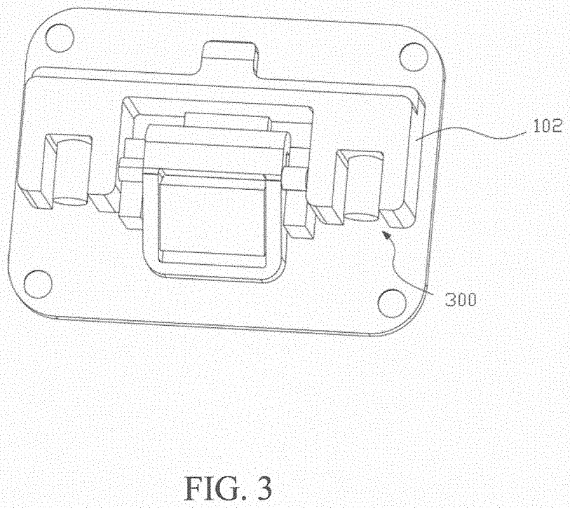

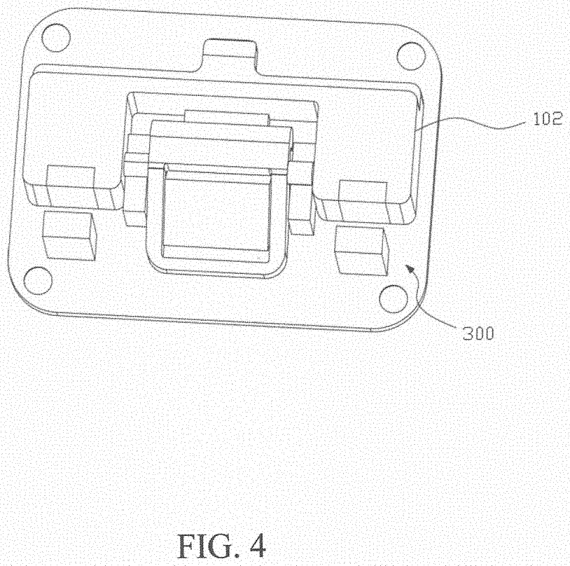

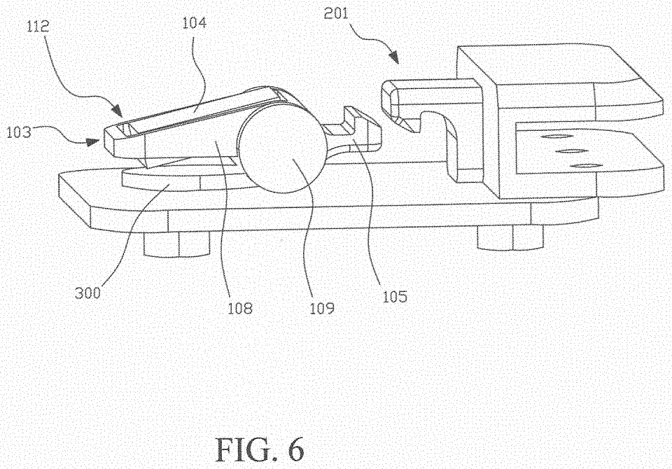

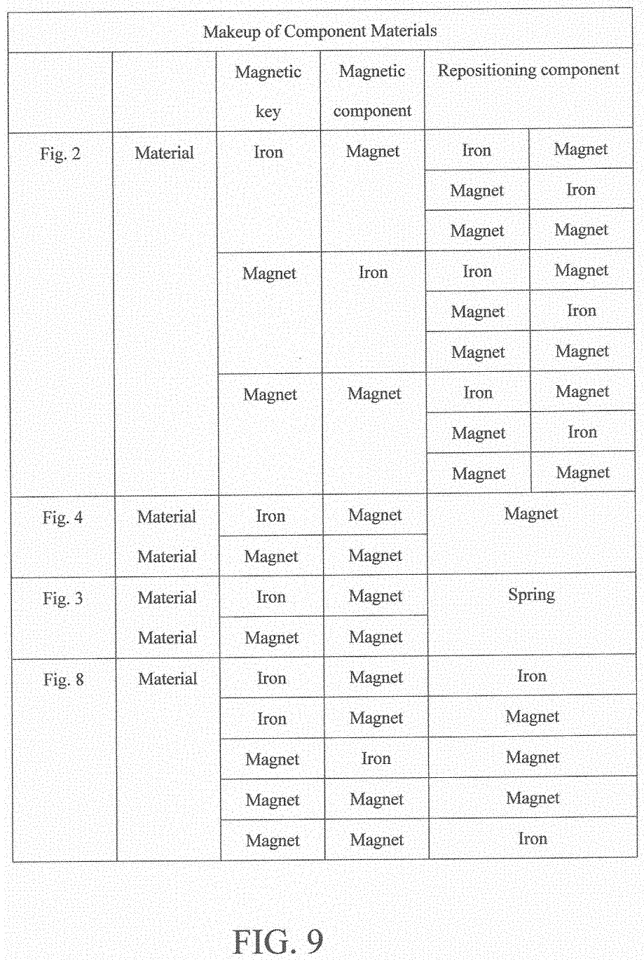

It should be noted that the magnetic component (104) in the above embodiments can be made of either magnets or iron. When the magnetic component (104) is made of magnets, the magnetic key (400) will be made of a magnet attracting the magnetic or iron component (104); if the magnetic component (104) is made of iron, the magnetic key (400) will be a magnet; similarly, the returning component (300) varies with its installation position. For possible installation positions of the returning component (300), please refer to FIG. 2, FIG. 3, FIG. 4, and FIG. 6 for details. The returning component (300) can be made of either springs, two magnets, or a magnet and a piece of iron. For a detailed review of the materials of the above components, please refer to FIG. 9 for details, which will not be repeated here.

Finally, it should be noted that the above embodiments are only used to explain the technical proposal of the invention, not to limiting the scope of protection of the invention. Although the invention is explained in detail by referring to the embodiments, general technicians in this field should understand that they can modify or equivalently substitute the details of the technical proposal in the invention without deviating from the essence and scope of the technical proposal in the invention.

1. A magnetic lock is characterized in that the magnetic lock comprises a fixed component and a movable component, wherein the movable component is used to connect with an external structure.
The fixed component comprises a shell, a sliding component arranged in the shell in a sliding way and a rotating component arranged in the shell in a rotating way, the rotating component is provided with a magnetic component, a locking piece is arranged at one end of the sliding component close to the movable component, and the movable component is provided with a fastener to fit with the locking piece, and the shell is provided with a through hole for exposing the locking piece and inserting the fastener.
When an external magnetic key is arranged close to the magnetic component, the magnetic component drives the rotating component to be in contact with the sliding component and drives the sliding component to slide away from the locking piece.

2. The magnetic lock in claim 1 is also characterized in that the magnetic lock also comprises a returning component arranged within the shell, wherein the returning component is positioned between the sliding component and the shell.

3. The magnetic lock in claim 1 is also characterized in that a fastener comprises a base and an insertion hole arranged on the base, and the shape of the insertion hole matches the shape of the locking piece.

4. The magnetic lock in claim 1 is also characterized in that a first curved surface is arranged on one side of the locking piece close to the fastener and a second curved surface matching the first curved surface is arranged on the side of the fastener close to the locking piece.

5. The magnetic lock in claim 1 is also characterized in that the rotating component comprises a rotating block and two rotating shafts. The two rotating shafts are arranged on both sides of the rotating block and are rotationally connected to the shell, and the magnetic component is arranged on the rotating block. A contact piece is arranged at one end of the rotating block close to the sliding component by folding and extending downwards, and an extension piece for ensuring contact with the contact piece is arranged at one end of the sliding component close to the rotating block.

6. The magnetic lock in claim 5 is characterized in that a holding slot is arranged on the rotating block, and the magnetic component is arranged in the holding slot.

7. The magnetic lock in claim 5 is characterized in that the extension piece adopts an L-shaped structure and is integrated into the sliding component.

8. The magnetic lock in claim 1 is characterized in that a yielding slot is arranged at the non-end position of the sliding component, and the rotating component is positioned in the yielding slot.
